(19) United States
(12) Patent Application Publication
(10) Pub. No.: US 2008/0174619 A1
(43) Pub. Date: Jul. 24, 2008

(54) Dispersion liquid manufacturing apparatus and dispersion liquid manufacturing method

(75) Inventor: Manabu Katsumura, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/902,910

(22) Filed: Sep. 26, 2007

(30) Foreign Application Priority Data
Sep. 27, 2006 (JP) 2006-263480

(51) Int. Cl. B41J 29/38

(52) U.S. Cl. 347/9

(57) ABSTRACT

A dispersion liquid manufacturing apparatus manufactures a dispersion liquid in which fine droplets of a second liquid are dispersed in a first liquid. The dispersion liquid manufacturing apparatus includes: a first liquid accommodating device which accommodates the first liquid; and an ejection head which has an ejection face opposing the first liquid accommodating device, the ejection head being disposed so that the ejection face is separated from a surface of the first liquid in the first liquid accommodating device by a prescribed distance, the ejection head ejecting the fine droplets of the second liquid from the ejection face to the surface of the first liquid through a gas phase between the ejection face and the surface of the first liquid.

### BACKGROUND OF THE INVENTION

1. Field of the Invention

The present invention relates to a dispersion liquid manufacturing apparatus and a dispersion liquid manufacturing method, and more particularly to technology for manufacturing a dispersion liquid in which very fine liquid droplets are dispersed in another liquid of a different type.

2. Description of the Related Art

An emulsified liquid (in the case of water and an oil, referred to as an “emulsion”) used in articles of food, cosmetics, and the like, is formed by dispersing and suspending one liquid in the form of very fine droplets, in another liquid with which it is immiscible. Emulsions are also used in the fields of medicine, and electronic materials, as well as articles of food and cosmetics. In an emulsion, if the droplet size of the dispersed very fine droplets is not uniformed, then problems arise in that the fine droplets combine (coalesce) with each other and become instable, and therefore technology has been proposed for manufacturing an emulsion by forming fine liquid droplets having a uniform particle size by using inkjet ejection technology, and ejecting the fine liquid droplets into another liquid. Since the liquid droplets formed by using inkjet ejection technology have a relatively uniform size, then droplets of standard size are dispersed in the solution (in other words, monodisperse state is achieved).

The invention described in Japanese Patent Application Publication No. 2005-254124 discloses technology for forming a dispersion liquid in which droplets composed of liquid 2 are dispersed in liquid 1, wherein the liquid 2 are dispersed in the liquid 1 by ejecting the droplets of the liquid 2 into the liquid 1 in pulse using a thermal inkjet nozzle.

However, in the invention described in Japanese Patent Application Publication No. 2005-254124, since the droplets of liquid 2 are ejected in a state where the front tip of the nozzle is in contact with the liquid 1, then this method is not beneficial to the formation of fine droplets of liquid 2 from the viewpoint of the viscosity of the liquid phase (liquid 1), as well as the fact that no evaporation of the flying droplets of the liquid 2 having been ejected toward the liquid 1 occurs. Furthermore, in the composition described in Japanese Patent Application Publication No. 2005-254124, if the liquid 2 is ejected continuously into the liquid 1, then since there is no deviation in the depositing positions of the droplets of the liquid 2 in the liquid 1, the ejected droplets of the liquid 2 may combine with each other in the liquid 1 when ejection is carried out at a high ejection frequency, and it is therefore difficult to obtain a desirable monodisperse state.

### SUMMARY OF THE INVENTION

The present invention has been contrived in view of these circumstances, an object thereof being to provide a dispersion liquid manufacturing apparatus and a dispersion liquid manufacturing method for manufacturing a dispersion liquid in which fine droplets of a liquid having a uniform droplet size are dispersed in another liquid, by ejecting the fine droplets of the liquid into the other liquid by using inkjet ejection technology.

In order to attain the aforementioned object, the present invention is directed to a dispersion liquid manufacturing apparatus which manufactures a dispersion liquid in which fine droplets of a second liquid are dispersed in a first liquid, the dispersion liquid manufacturing apparatus including: a first liquid accommodating device which accommodates the first liquid; and an ejection head which has an ejection face opposing the first liquid accommodating device, the ejection head being disposed so that the ejection face is separated from a surface of the first liquid in the first liquid accommodating device by a prescribed distance, the ejection head ejecting the fine droplets of the second liquid from the ejection face to the surface of the first liquid through a gas phase between the ejection face and the surface of the first liquid.

According to this aspect of the present invention, the second liquid is ejected to the first liquid via a gas phase, and therefore, in comparison with a case where the second liquid is ejected to the first liquid without passing via a gas phase, beneficial effects are obtained with respect to the formation of fine droplets of the second liquid, since the gas phase has a viscosity that is low compared to that of the liquid phase, and the droplets of the second liquid are liable to be evaporated in the gas phase. Therefore, it is possible to form highly-monodispersed liquid droplets with a very small diameter.

Furthermore, in a case where the second liquid is ejected directly to the first liquid without passing through a gas phase, it is necessary to employ an actuator which generates a large ejection force, for instance, a thermal actuator, for the ejection force application device which applies an ejection force to the second liquid. On the other hand, in a case where the second liquid is ejected to the first liquid via a gas phase, it is possible to employ other types of ejection method, such as a piezoelectric ejection method, which produce a small ejection pressure compared to a thermal method.

Moreover, since the ejection head (second liquid) and the first liquid are separated by a gas phase (in other words, the ejection face and the surface of the first liquid in the first liquid accommodating device is separated by a prescribed distance), then it is possible to individually adjust the temperature of the first liquid and the temperature of the second liquid, and it is also possible to prevent reverse flow of the second liquid into the ejection head.

There is a mode in which the ejection head includes a nozzle (ejection aperture) for ejecting the second liquid, a pressure chamber connected to the ejection aperture, a pressure generating device (actuator) for applying an ejection pressure to the second liquid inside the pressure chamber, and a second liquid supply device for supplying the second liquid to the pressure chamber.

The ejection head is separated by a prescribed distance from the surface of the first liquid on which the second liquid is deposited. The distance between the ejection face and the surface of the first liquid is desirably not less than 0.3 mm and not greater than 5.0 mm, and more desirably, it is not less than 0.5 mm and not greater than 1.0 mm.

Preferably, the dispersion liquid manufacturing apparatus further includes a movement device which moves the first liquid and the ejection head relatively to each other at a fixed speed in one direction while the ejection head ejects the fine droplets of the second liquid from the ejection face to the surface of the first liquid.

According to this aspect of the present invention, even if the second liquid is ejected continuously at a prescribed ejection interval, a plurality of droplets of second liquid are prevented from depositing at substantially the same timing at the same position on the surface of the first liquid to which the second liquid is ejected, and combination (coalescence) of the droplets of second liquid in the first liquid is avoided.

Possible modes of moving the first liquid and the ejection head relatively to each other include a mode in which the first liquid accommodating member is fixed and the ejection head is moved with respect to the first liquid accommodating member, and a mode where the first liquid accommodating member is moved with respect to a fixed ejection head. Of course, it is also possible to move both the first liquid accommodating member and the ejection head.

Preferably, the dispersion liquid manufacturing apparatus further includes a laminar flow generating device which generates a laminar flow of the first liquid accommodated in the first liquid accommodating device so that the first liquid flows in a flow direction.

According to this aspect of the present invention, by generating the laminar flow in the first liquid, the depositing position of the second liquid in the first liquid is progressively displaced even when the second liquid is ejected continuously at prescribed ejection intervals, and therefore it is possible to prevent the droplets of second liquid from combining together in the first liquid and a desirable monodisperse state can be achieved.

Possible modes of generating a laminar flow in the first liquid include a mode in which a pump disposed between the first liquid accommodating device and the first liquid tank is operated, and the first liquid is supplied from the first liquid tank to the first liquid accommodating device. In this case, a preferred mode is one in which the flow speed of the first liquid supplied from the first liquid tank to the first liquid accommodating device is measured, and the pump is controlled in accordance with the measured flow speed so that the flow speed of the first liquid does not deviate from the laminar region.

Preferably, the first liquid accommodating device includes a plurality of grooves which have a width corresponding to a size of the fine droplets, the plurality of grooves being formed along the flow direction of the laminar flow of the first liquid.

According to this aspect of the present invention, it is possible to generate a desirable laminar flow by providing a plurality of grooves in the first liquid accommodating member, the grooves being formed along the direction of flow of the laminar flow of first liquid. If the grooves have a large width, then turbulence is liable to occur, and therefore it is desirable that the grooves have a width of not greater than 1 mm.

Preferably, the first liquid accommodating device includes a plurality of recess sections which accommodate the first liquid and which correspond to a size of the fine droplets of the second liquid, the plurality of recess sections being arranged in a two-dimensional configuration in parallel with the ejection face.

According to this aspect of the present invention, it is possible to eject fine droplets of the second liquid individually (droplet by droplet), to the first liquid accommodated in the recess sections.

Preferably, the dispersion liquid manufacturing apparatus further includes an electrical field generating device which generates an electrical field in the gas phase between the ejection face and the surface of the first liquid.

According to this aspect of the present invention, the droplets of the second liquid in flight are subjected to an electrical field, by applying an electrical field to the gas phase in the space through which the ejected droplets of the second liquid fly, and thereby it is possible to assist the droplets of the second liquid to be incorporated into the first liquid or to separate the satellite droplets accompanying the main droplets (fine droplets of the second liquid) from the main droplets (fine droplets of the second liquid).

It is also possible to use another type of field, instead of the electrical field, such as heat, light, electromagnetic waves, a magnetic field, atmospheric-pressure plasma, and the like.

Preferably, if the ejection head ejects satellite droplets accompanying the fine droplets of the second liquid, then the electrical field generating device separates the satellite droplets from the fine droplets.

According to this aspect of the present invention, it is possible readily to separate the satellite droplets from the main droplets of the second liquid, and therefore a desirable dispersion liquid having uniform liquid droplet size can be obtained.

Preferably, the electrical field generating device assists the fine droplets of the second liquid to be incorporated into the first liquid.

According to this aspect of the present invention, the direction of flight of the droplets of the second liquid is stabilized, and the droplets of the second liquid can reliably arrive at the surface of the first liquid.

Preferably, the dispersion liquid manufacturing apparatus further includes a solidification device which solidifies the fine droplets of the second liquid dispersed in the first liquid.

According to this aspect of the present invention, it is possible to continuously (uninterruptedly) carry out the generation of a dispersion liquid and a step of solidifying the droplets in the dispersion liquid, and therefore improved production efficiency can be expected.

Preferably, the dispersion liquid manufacturing apparatus further includes an inspection device which inspects at least one of a size, a shape and an internal state of the fine droplets of the second liquid dispersed in the first liquid.

According to this aspect of the present invention, it is possible to achieve a continuous process, including the inspection step, and therefore further improvement in production efficiency can be expected.

Preferably, the dispersion liquid manufacturing apparatus further includes a classification device which classifies the fine droplets of the second liquid dispersed in the first liquid.

According to this aspect of the present invention, it is possible to achieve a continuous process, including the classification step, and therefore further improvement in production efficiency can be expected.

Preferably, the dispersion liquid manufacturing apparatus further includes an extraction device (also referred to as a “recovery device” or a “collection device”) which separately extracts (collects) the dispersion liquid in which the fine droplets of the second liquid are dispersed in the first liquid, according to classes of the fine droplets of the second liquid classified by the classification device.

According to this aspect of the present invention, it is possible to carry out the steps from generation of a dispersion liquid until outputting the manufactured dispersion liquid (extraction of the dispersion liquid), by means of a continuous process, and therefore further improvement in production efficiency can be expected.

Moreover, in order to attain the aforementioned object, the present invention is also directed to a method of manufacturing a dispersion liquid, including a step of dispersing fine droplets of a second liquid in a first liquid by ejecting the fine droplets of the second liquid to the first liquid through a gas phase.

According to the present invention, the second liquid is ejected to the first liquid via a gas phase, and therefore, in comparison with a case where the second liquid is ejected to the first liquid without passing via a gas phase, beneficial effects are obtained with respect to the formation of fine droplets of the second liquid, since the viscosity of the gas phase is low compared to that of the liquid phase, and evaporation of the droplets of the second liquid is liable to occur in the gas phase. Therefore, it is possible to form highly-monodispersed liquid droplets with a very small diameter.

Moreover, in a case where the second liquid is ejected to the first liquid without passing through a gas phase, it is necessary to employ an actuator which generates a large ejection force, for instance, a thermal actuator, for the ejection force application device which applies an ejection force to the second liquid. On the other hand, in a case where the second liquid is ejected to the first liquid via a gas phase, it is possible to employ other types of ejection method, such as a piezoelectric ejection method, which produce a small ejection pressure compared to a thermal method.

Furthermore, since the ejection head (second liquid) and the first liquid are separated by a gas phase, then it is possible to individually adjust the temperature of the first liquid and the temperature of the second liquid, and it is also possible to prevent reverse flow of the second liquid into the ejection head.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIG. 1 is a basic schematic drawing of a dispersion liquid manufacturing apparatus according to an embodiment of the present invention;

FIGS. 2A and 2B are diagrams showing relative movement between water and the ejection head during ejection of oil droplets;

FIG. 3A is a schematic plan diagram of the dispersion liquid manufacturing apparatus shown in FIG. 1;

FIG. 3B is a schematic plan diagram showing a dispersion liquid manufacturing apparatus according to another embodiment of the present invention;

FIGS. 4A and 4B are diagrams showing compositional examples of a flow channel unit according to an embodiment of the present invention;

FIGS. 5A to 5C are plan diagrams showing examples of nozzle arrangements in the ejection head shown in FIG. 1;

FIG. 6 is a cross-sectional diagram showing the three-dimensional structure of the ejection head;

FIG. 7 is a cross-sectional diagram showing the composition of a supply system of the dispersion liquid manufacturing apparatus shown in FIG. 1;

FIG. 8 is a principal block diagram showing the system configuration of the dispersion liquid manufacturing apparatus shown in FIG. 1;

FIG. 9 is a basic schematic drawing showing a dispersion liquid manufacturing apparatus according to an application embodiment of the present invention;

FIGS. 10A and 10B are diagrams illustrating the recovery of a satellite droplet;

FIGS. 11A and 11B are diagrams showing another mode of the recovery of the satellite droplet shown in FIGS. 10A and 10B;

FIGS. 12A to 12C are diagrams showing examples of the composition of the electrode pair in FIG. 9;

FIG. 13 is a schematic plan diagram of the dispersion liquid manufacturing apparatus shown in FIG. 9;

FIG. 14 is a basic schematic drawing of a dispersion liquid manufacturing apparatus according to another application embodiment of the present invention;

FIGS. 15A and 15B are oblique diagrams showing examples of the structure of the containers shown in FIG. 14; and

FIG. 16 is a diagram showing an aspect in which dispersed particles having a circular disk shape are manufactured.

### DETAILED DESCRIPTION OF THE PREFERRED EMBODIMENTS

### General Composition of Apparatus

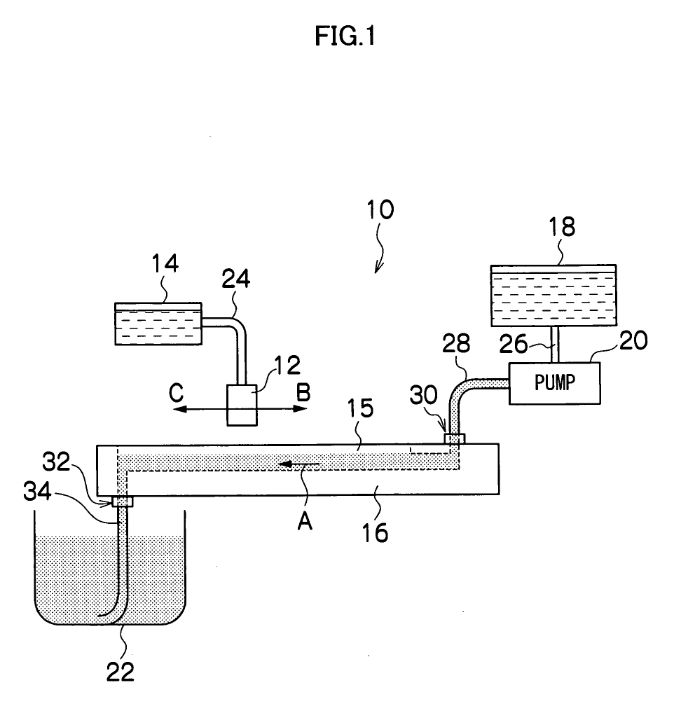

FIG. 1 is a diagram showing a general schematic drawing of a dispersion liquid manufacturing apparatus according to an embodiment of the present invention. The dispersion liquid manufacturing apparatus 10 shown in FIG. 1 is a dispersion liquid manufacturing apparatus which manufactures an emulsion (dispersion liquid) for articles of food, such as a dressing, margarine, health food product, or the like, by dispersing fine droplets of uniform droplet size of an organic compound, an oil, fat, or the like, in water or a water-based solution.

The dispersion liquid manufacturing apparatus 10 shown in FIG. 1 includes: an ejection head 12 of inkjet type which ejects an oil (second liquid) to be dispersed in water or a water-based solution (first liquid), in the form of very fine droplets having a uniform droplet size; a second liquid tank 14 which stores oil to be supplied to the ejection head 12; a flow channel unit (corresponding to a “first liquid accommodating device”) 16 mainly composed of a pool 15 which accommodates water forming the dispersion medium in which the oil droplets are to be dispersed and which has an opening on the surface opposing the ejection face of the ejection head 12; a first liquid tank 18 which stores water to be supplied to the flow channel unit 16; a pump (corresponding to a “laminar flow generating device”) 20 which generates a laminar flow by applying pressure to the water inside the flow channel unit 16; and an extraction device (recovery device) 22 which extracts (recovers) emulsion in which droplets of oil are dispersed in water, from the flow channel unit 16 (in other words, the produced emulsified liquid is output to and stored in the extraction device 22).

The ejection head 12 is disposed over the pool 15 so as to face toward the opening surface of the pool 15 (the surface toward which oil droplets are ejected), in such a manner that the ejection head 12 is separated from the liquid surface of the pool 15 (the surface where the droplets of oil deposit) by a prescribed distance (of 0.3 mm to 5.0 mm), and the droplets of oil ejected from the ejection head 12 are ejected into the air (gas phase) between the ejection head 12 and the pool 15 and then deposit on the water in the pool 15 after passing through the air. In a method of this kind in which the oil droplets are ejected onto the water in the pool 15 via a gas phase (air), since the viscosity of the gas phase is lower than that of the liquid phase (more specifically, the droplets are not slowed down) and evaporation of the oil is able to occur in the gas phase, then this method is beneficial for the formation of fine droplets, compared to a method where the oil droplets are ejected directly into the liquid phase without passing through a gas phase (air), as in a micro-channel reactor.

The second liquid tank 14 stores oil to be supplied to the ejection head 12, and it is connected to the ejection head 12 via the flow channel 24. Furthermore, the second liquid tank 14 includes a notification device (a display device, an alarm sound generating device, or the like) which issues a notification if the remaining amount of oil has become low, and in a mode where a liquid other than oil is also used, it also has a mechanism for preventing mistaken loading of the wrong type of liquid.

The first liquid tank 18 is connected to the pool 15 provided in the flow channel unit 16, via flow channels 26 and 28 and the pump 20. Similarly to the second liquid tank 14, in a mode where a plurality of liquids are used, the first liquid tank 18 has a mechanism which prevents mistaken loading of the wrong type of liquid.

When the pump 20 is operated, the water stored in the first liquid tank 18 is introduced to the pool 15 through an inlet 30 provided in the upper face (ceiling face) of the flow channel unit 16, via the flow channel 26, the pump 20 and the flow channel 28, and thereby a laminar flow is generated in the water inside the pool 15. The pressure generated by the pump 20 is controlled in such a manner that a stable laminar flow is generated in the water inside the pool 15, and the pump 20 functions as a device for supplying water to the pool 15, and as a device for generating a laminar flow in the water inside the pool 15. A desirable mode is one in which a flow speed sensor for measuring the flow speed of the laminar flow generated in the pool 15 is provided, and the pressure generated by the pump 20 is controlled in such a manner that the flow speed of the laminar flow does not fall within the region of turbulent flow (in other word, in such a manner that the liquid flow in the pool 15 does not become the turbulent flow).

Instead of generating a laminar flow in the water inside the flow channel unit 16, it is also possible to compose the ejection head 12 in such a manner that the ejection head 13 moves in a prescribed direction relative to the pool 15 (for example, the flow direction of the laminar flow described above). In this case, the scanning direction of the ejection head 12 may be the direction indicated by reference numeral B in FIG. 1, or it may be the direction indicated by reference numeral C in FIG. 1.

Here, a “laminar flow” refers to a state where the liquid flows in an orderly fashion without disturbance to the flow of water in the pool 15, and in the present invention, a “laminar flow” means a state in which a relationship of Re<2300 is satisfied, where Re is the Reynold's number that is expressed by the expression of ((characteristic speed)×(characteristic length))/((viscosity coefficient)/(mass density)). The “laminar flow” may include not only a state where all of the water in the pool 15 always flows in one direction but also a state where the flow of water which has collided with the inner walls flows along the inner walls, in the outermost of the pool 15 (in the vicinity of the inner walls).

The “characteristic speed” mentioned above means the typical speed (representative speed) in the “laminar flow”, and the “characteristic length” means the typical length (representative length) in the “laminar flow”. In the case of a liquid flowing in a tube, the “typical length” is the tube diameter of the narrowest portion in the tube, and the “typical speed” is the flow speed in the portion corresponding to the typical length.

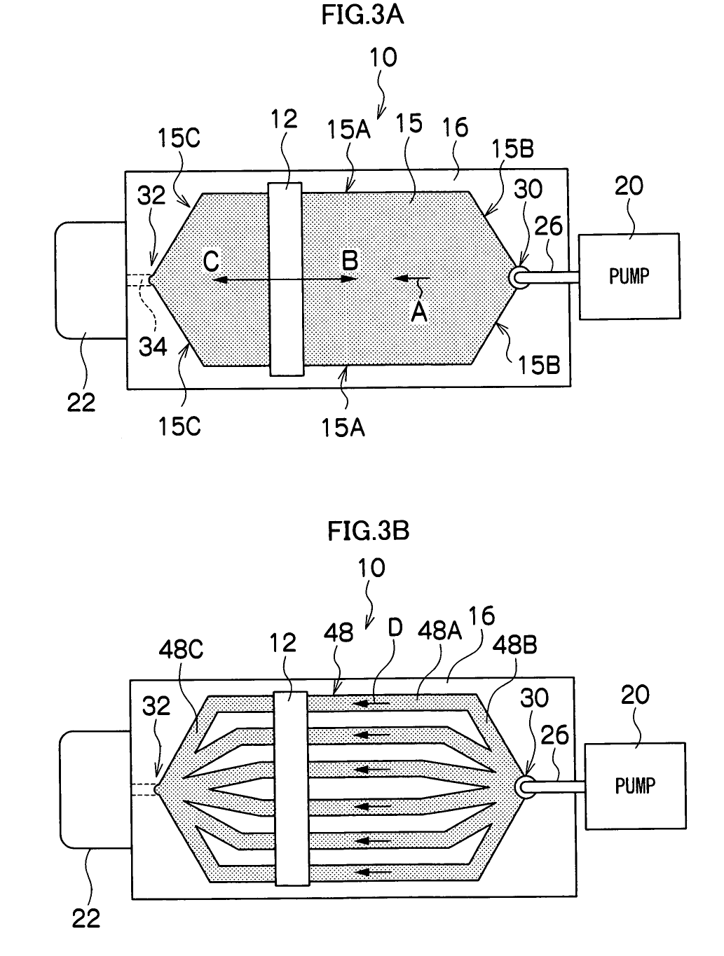

The ejection head 12 is constituted of a line type of head in which a plurality of nozzles are arranged through a length exceeding the maximum width of the opening of the pool 15 (see FIGS. 3A and 3B). In this way, by means of a full line type of ejection head 12 which covers the full width of the pool 15, it is possible to eject very fine oil droplets through the whole width region of the pool 15 by means of a single ejection operation, and thereby the productivity can be improved in comparison with a serial type of ejection head which ejects oil through the whole width region of the pool 15 by using a short head which is shorter than the width of the pool 15 and by moving this short head in the breadthways direction of the pool 15 repeatedly.

In the present embodiment, a full line type of head is used which corresponds to the whole width of the pool 15 in the breadthways direction (the direction perpendicular to the flow direction A in FIG. 1 of the laminar flow of water in the pool 15), but it is also possible to use the serial type of ejection head described above.

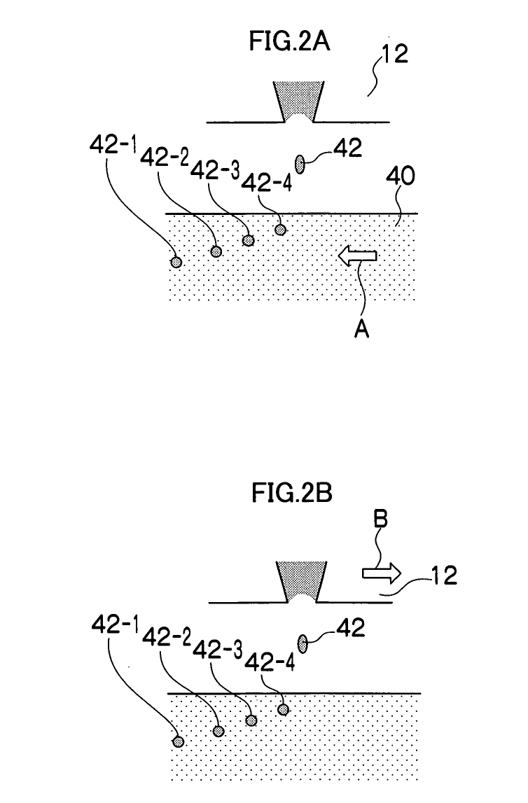

FIG. 2A is a diagram showing a state where an emulsified liquid is created by ejecting fine droplets 42 of oil from the ejection head 12, into water 40 in which the laminar flow has been generated. When the fine droplets 42 of oil having a uniform droplet size are ejected from the ejection head 12 onto the water 40 in which the laminar flow has been generated, a monodisperse emulsified liquid is created in which oil droplets of uniform size are dispersed in the dispersion medium (water).

Due to the action of the laminar flow in the water, even if oil droplets 42-1, 42-2, 42-3, 42-4, and the like, are ejected continuously at a high ejection frequency of several ten kilohertz (kHz) to several hundred kilohertz (kHz), from the ejection head 12, the oil droplets 42-1, 42-2, 42-3, 42-4, and the like depositing on the water move (are conveyed by the laminar flow) in the flow direction A of the laminar flow, with the passage of time, and consequently there is no combination (coalescence) between any two adjacent oil droplets in the water, or on the surface of the water, and an emulsion which maintains a desirable monodisperse state is created.

FIG. 2B is a diagram showing a state where an emulsion is created by moving the ejection head 12 in the direction denoted with reference symbol B. By moving the ejection head 12, it is possible to vary the depositing positions of the consecutively ejected oil droplets 42-1, 42-2, 42-3, 42-4, and the like, and similarly to the mode shown in FIG. 2A, a desirable emulsion is created which maintains a monodisperse state of the oil droplets 42-1, 42-2, 42-3, 42-4, and the like, deposited in the water.

The emulsion (emulsified liquid) generated in this way is sent to the extraction vessel 22 via an extraction flow channel 34, from an extraction port 32 provided in the bottom face of the pool 15. The emulsion accommodated in the extraction vessel 22 is then subjected to subsequent processing steps of inspection, classification, packaging, and so on.

FIG. 3A is a plan diagram showing the dispersion liquid manufacturing apparatus 10 as viewed from the upper side of the ejection head 12, and FIG. 3B is a diagram showing a further example of the dispersion liquid manufacturing apparatus 10 shown in FIG. 3A with another structure of the pool 15.

As shown in FIG. 3A, the pool 15 has a substantially hexagonal planar shape, which is elongated in such a manner that the length of the base edges 15A is longer than the total length of the base edge direction component of the inclined edges 15B and the inclined edges 15C (the total length of the base edge direction component of the inclined edges), and the base edges 15A are formed in a direction which is perpendicular to the lengthwise direction of the ejection head (inkjet head) 12. As shown if FIG. 3A, the flow channel unit 16 itself also has a substantially rectangular planar shape, which is elongated in the direction perpendicular to the lengthwise direction of the ejection head 12.

The inlet 30 through which water is supplied from the first liquid tank 18 (see FIG. 1) via the pump 20 is provided in substantially the central portion of one end of the pool 15 in the lengthwise direction (the right-hand side end portion in FIG. 3A), and the extraction port 32 which connects to the extraction vessel 22 is provided in substantially the central portion of the other end (the left-hand side end portion in FIG. 3A). In the pool 15, the laminar flow is generated along the lengthwise direction (the direction parallel to the base edges 15A) of the pool 15.

Furthermore, the pool 15 has a structure in which the angle between the walls of the base edges 15A and the walls of the inclined edges 15B, and the angle between the walls of the base edges 15A and the walls of the inclined edges 15C exceeds 90°, and therefore stagnation of the flow of water is suppressed in the vicinity of the junctions between the walls of the base edges 15A and the walls of the inclined edges 15B or the inclined edges 15C, and the desirable laminar flow is generated in the water in the pool 15.

FIG. 3B shows an aspect in which a plurality of micro-channels (very fine flow channels) 48 having a width of several micrometers (μm) to several hundred micrometers (μm) are provided, instead of a single body of the pool 15 as shown in FIG. 3A.

As shown in FIG. 3B, the plurality of micro-channels 48 are arranged in the lengthwise direction of the ejection head 12 in such a manner that one end of each micro-channel 48 is connected to the inlet 30 and the other end thereof is connected to the extraction port 32. The laminar flow is generated in the direction from the inlet 30 to the extraciton port 32 (the direction indicated by reference symbol D).

The micro-channels 48 shown in FIG. 3B are constituted of longer edge sections 48A which follow a direction perpendicular to the lengthwise direction of the ejection head 12, inclined edge sections 48B each of which forms an angle greater than 90° with respect to the corresponding longer edge 48A, and inclined edge sections 48C each of which forms an angle greater than 90° with respect to the corresponding long edge section 48A. One end of each of the inclined edge sections 48B is connected to the corresponding long edge section 48A and the other end thereof is connected to the inlet 30. One end of each of the inclined edge sections 48 is connected to the corresponding long edge section 48A and the other end thereof is connected to the extraction port 32.

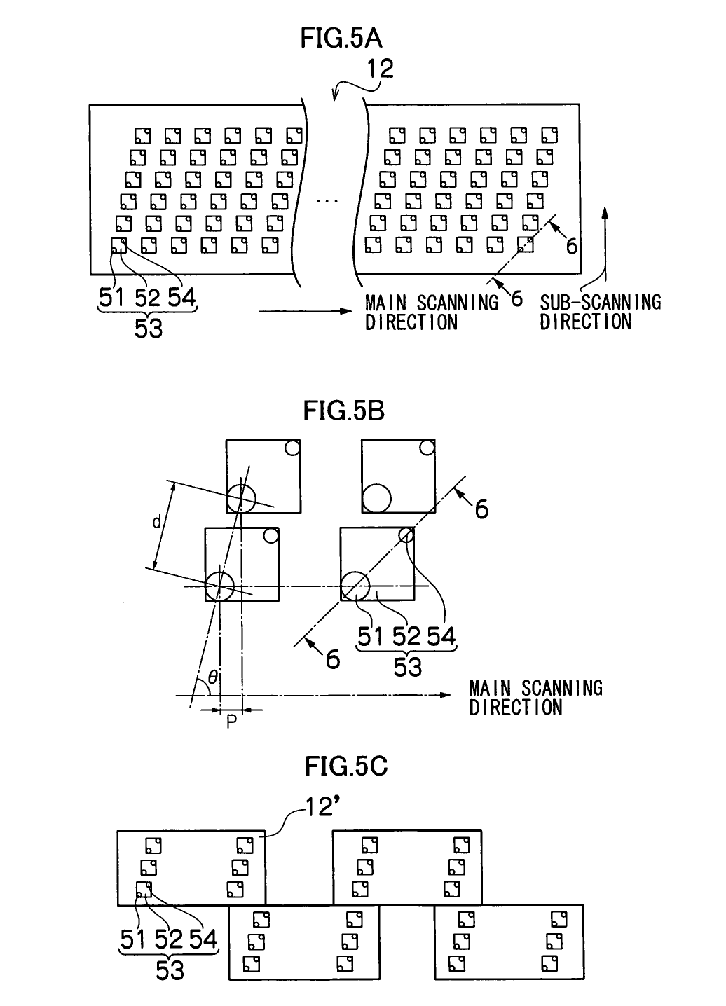

FIG. 3B shows a structure in which the plurality of micro-channels 48 branch off from the vicinity of the inlet 30, and the plurality of micro-channels 48 converge in the vicinity of the extraction port 32, but it is also possible to adopt a structure in which a plurality of inlets 30, extraction ports 32 and flow channels 26 and 34 are provided for the micro-channels 48, respectively (in other words, the number of the inlets 30, extraction ports 32 and flow channels 26 and 34 corresponds to the number of the micro-channels 48). Apart from this, it is also possible to adopt a structure in which the inlet 30 and the extraction port 32 have an elongated shape in the breadthways direction of the flow channel unit 16 and one end of the long edge sections 48A connects to the elongated inlet 30, while the other end thereof connects to the elongated extraction port 32. Moreover, the number and arrangement of the micro-channels 48 is determined in accordance with the number and arrangement of the nozzles (see FIGS. 5A and 5B) of the ejection head 12.

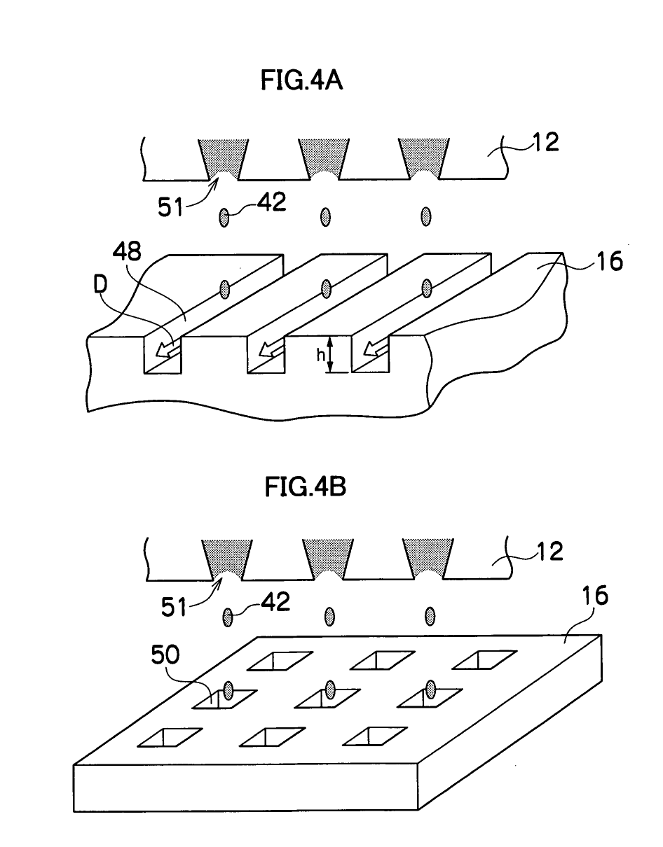

FIG. 4A is a diagram showing a state where the fine oil droplets 42 are ejected toward the plurality of micro-channels 48 from the plurality of nozzles 51. A laminar flow having the flow direction indicated by reference symbol D is generated in each of the micro-channels 48 shown in FIG. 4A. The arrangement of the micro-channels 48 and the nozzles 51 are determined in such a manner that, the fine oil droplets 42 are ejected from different nozzles 51, at the same timing, onto the same position in terms of the flow direction of the laminar flow (the direction in the which channel 48 is formed) in each of the micro-channels 48.

As shown in FIG. 4A, by generating a laminar flow in the direction indicated by reference symbol D in the micro-channels 48, and by successively ejecting fine droplets 42 of oil from the ejection head 12, then combining together (coalescence) of the fine droplets 42 of oil inside the micro-channels 48 is suppressed and a desirable emulsion which maintains a monodisperse state can be generated.

If the thickness h of the micro-channels 48 is large, then turbulence is liable to occur inside the micro-channels 48, and therefore it is desirable that the thickness h of the micro-channels 48 be equal to or less than 1 mm.

Instead of the micro-channels 48 shown in FIG. 4A, it is also possible to arrange very small boxes 50 as shown in FIG. 4B in the flow channel unit 16. The small boxes 50 accommodate water forming the dispersion medium, and they have an opening of a surface area greater than the droplet size of the oil droplets ejected from the ejection head 12, on the surface opposing the ejection surface of the ejection head 12. Furthermore, there is a one to one correspondence between the nozzles of the ejection head 12 and the small boxes 50, and the oil droplets 42 can be accommodated in units of one droplet (droplet by droplet), inside the small boxes 50.

By ejecting droplets of oil into the respective small boxes 50, using different nozzles, while the flow channel unit 16 including the small boxes 50 as shown in FIG. 4B and the ejection head 12 are moved relatively to each other in one direction, it is possible to create a desirable emulsion which maintains a monodisperse state, without the occurrence of combining (coalescence) between droplets of oil inside the small boxes 50.

Furthermore, by heating or cooling the flow channel unit 16 in a state where an emulsion (emulsified liquid) has been generated in the small boxes 50, it is possible to form the dispersed droplets in the emulsion inside the small boxes 50 into powder particles (by solidifying the dispersed liquid droplets). In this case, the step of temporarily collecting emulsion from the flow channel unit 16 prior to powder processing (processing whereby the dispersed liquid droplets in the emulsion are converted into powder particles) can be omitted.

### Description of Structure of Ejection Head

Next, the structure of the ejection head 12 will be described in detail. FIG. 5A is a plan view perspective diagram showing an example of the structure of the ejection head 12; and FIG. 5B is a diagram showing enlarged view of the ejection head 12 shown in FIG. 5A. Furthermore, FIG. 5C is a plan view perspective diagram showing a further example of the structure of the ejection head 12.

As shown in FIGS. 5A and 5B, the ejection head 12 according to the present embodiment has a structure in which a plurality of ejection elements 53, each including a nozzle 51 from which an oil droplet is ejected and a pressure chamber 52 connecting to the respective nozzle 51, and the like, are disposed in the form of a staggered matrix, and the effective nozzle pitch is thereby made small.

In other words, as shown in FIGS. 5A and 5B, the ejection head 12 according to the present embodiment is a full line head having one or more nozzle row in which a plurality of nozzles 51 which eject droplets of oil are arranged following the main scanning direction, through a length corresponding to the width of the ejection region. In the case of a compositional example shown in FIG. 3A, the ejection region corresponds to the width of the pool 15 in the direction substantially perpendicular to the flow direction of the laminar flow in the pool 15. In the case of a compositional example shown in FIG. 3B, the ejection region corresponds to the width through which the micro-channels 48 are formed.

Moreover, as shown in FIG. 5C, it is also possible to use a plurality of heads 12′ having nozzles arranged through a short length in a two-dimensional fashion, and to combine the heads 12′ in a zigzag arrangement, whereby a length corresponding to the full width of the ejection region is achieved. Furthermore, although not shown in FIGS. 5A to 5C, it is also possible to connect short heads in a linear fashion.

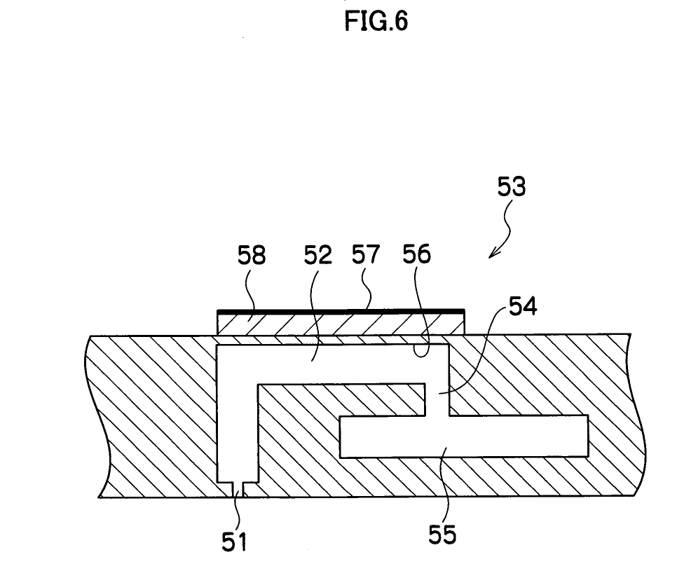

As shown in FIGS. 5A to 5C, the pressure chamber 52 provided so as to correspond to each of the nozzles 51 is approximately square-shaped in plan view, and the nozzle 51 and the supply port 54 are provided respectively at either corner of a diagonal of the pressure chamber 52. Moreover, the pressure chambers 52 are each connected via the supply port 54 to a common liquid chamber (not shown in FIGS. 5A to 5C; and denoted with reference numeral 55 in FIG. 6).

As shown in FIG. 5B, the plurality of ejection elements 53 having the above-described structure are disposed in a lattice arrangement, based on a fixed arrangement pattern having a row direction which coincides with the main scanning direction, and a column direction which, rather than being perpendicular to the main scanning direction, is inclined at a fixed angle of θ with respect to the main scanning direction. By adopting a structure in which the plurality of ejection elements 53 are arranged at a uniform pitch d in a direction having an angle θ with respect to the main scanning direction, the pitch P of the nozzles projected so as to align in the main scanning direction is d×cos θ.

More specifically, the arrangement can be treated equivalently to one in which the nozzles 51 are arranged in a linear fashion at uniform pitch P, in the main scanning direction. By means of this composition, it is possible to achieve a composition of high nozzle density, in which the nozzle columns projected to align in the main scanning direction reach a total of 2400 per inch (2400 nozzles per inch).

Desirably, the pitch P of the nozzles projected to an alignment in the main scanning direction shown in FIG. 5B is the same as the arrangement pitch of the micro-channels 48 shown in FIG. 3B. Furthermore, desirably, the arrangement of the small boxes 50 shown in FIG. 4B coincides with the arrangement of the nozzles 51 shown in FIG. 5B.

FIG. 6 is a cross-sectional diagram showing the three-dimensional composition of the ejection head 12 (a cross-sectional diagram along line 6-6 in FIGS. 5A and 5B). A piezoelectric element 58 provided with an individual electrode 57 is bonded to the diaphragm 56 which constitutes the ceiling of the pressure chambers 52. The diaphragm 56 also functions as a common electrode for the piezoelectric elements 58. By applying a drive voltage to the individual electrode 57, a bending deformation is applied to the piezoelectric element 58, the pressure chamber 52 is deformed, and an oil droplet is ejected from the nozzle S1. When an oil droplet is ejected from the nozzle, new oil is supplied to the pressure chamber 52 from the common flow chamber 55, via the supply port 54.

A thermal jet method or a piezojet method is suitable for use as the ejection method in a general ejection head. A thermal jet method is a method in which an ejection force is obtained by generating an ejection bubble by means of a film boiling effect. In the thermal jet method, scorching of the liquid (the creation of solid material as a result of the heating process) typically occurs in the liquid when the liquid is heated to generate the ejection bubble. Therefore, the liquid to be ejected by means of the ejection bubble is basically limited to a water-based liquid, which is not liable to produce scorching. Consequently, when considering the manufacture of a dispersion liquid, in the case of the thermal jet method, the dispersion liquid is limited to being a liquid in which water-based liquid droplets (droplets ejected by means of the ejection bubble) are dispersed into an oil-based solution. On the other hand, in the case of a piezojet method, it is possible to use either a water-based liquid or an oil-based liquid as the liquid to be ejected (i.e., as the liquid to be dispersed in another liquid), and therefore the piezojet method has a characteristic feature in that it allows broad freedom of choice of the usable liquid, compared to a thermal jet method.

Furthermore, in an ejection head using a thermal jet method, it is necessary to form a thermal actuator section (for example, a heater) inside the liquid flow channel, and therefore the lifespan of the ejection head tends to become shorter along with the lifespan of this thermal actuator section. Furthermore, the properties also decline with sedimentation of the liquid, and in general, the lifespan is shorter than in an ejection head which uses a piezojet method. Unlike image formation, there may be a case in which liquid is to be ejected continuously in the manufacture of a dispersion liquid such as that according to the present embodiment, and therefore an ejection head using a piezojet method is extremely beneficial for manufacturing a dispersion liquid, since it has a longer lifespan than an ejection head using a thermal jet method.

In a thermal jet method, the modulation of the droplet ejection volume is basically limited to two values only, one of which is a value for ejection and the other of which is a value for non-ejection. On the other hand, in a piezojet method, it is generally possible to modulate the droplet ejection volume within a range up to approximately 10 times the minimum ejectable droplet volume (a range from the minimum ejectable droplet volume through 10 times the minimum ejectable droplet volume). In other words, an ejection head based on a piezojet method does not require replacement of the head when modulating the size of the dispersion liquid, and therefore it has excellent adaptability to use in the manufacture of a dispersion liquid.

A thermal jet method produces energy loss during ejection of 5 times to 10 times greater than that of a piezojet method. In other words, the piezojet method also has excellent energy efficiency compared to a thermal jet method, and it is outstanding in terms of manufacturing costs.

In a thermal jet method, the actuator sections (heat generating bodies) can be manufactured with a small size, and this is beneficial for achieving higher integration of the ejection head, compared to a piezojet method. However, since a piezojet method has excellent properties in terms of the long lifespan of the (PZT) actuators, the absence of restrictions on the usable liquids, the ease of modulating the ejection volume, and the outstanding energy efficiency during ejection, then a piezojet method is more desirable than a thermal jet method for use in the manufacture of a dispersion liquid.

Here, the concepts of ejecting liquid droplets “through a gas phase” and ejecting liquid droplets directly into the liquid phase “without passing through a gas phase”, are explained in detail, in terms of achieving very fine droplets and raising the ejection frequency (the liquid droplet generation frequency).

The forces of resistance considered to be acting when a droplet is ejected from a nozzle are: the interface tension between the droplet and the continuous phase (bulk phase), the viscosity coefficient of the continuous phase (bulk phase) and the density of continuous phase (bulk phase). Here, the “continuous phase (bulk phase)” is the phase on the side toward which the droplet is ejected from the nozzle, for example, in the case of an inkjet recording apparatus which forms an image, it is a gas phase (air phase).

Even if the above-described continuous phase of a gas phase is replaced with a liquid phase, there is no major change in the physical value of the interface tension between the droplet and the continuous phase. No major difference therefore occurs between a case where a droplet is ejected through a gas phase and a case where a droplet is ejected directly into a liquid phase without passing through a gas phase. Consequently, it can be concluded that the interface tension between the droplet and the continuous phase does not affect achieving very fine droplets and raising the ejection frequency to a considerable extent.

Whereas, if the continuous phase of a gas phase is replaced with a liquid phase, then the physical values of the viscosity coefficient of the continuous phase (in this case, liquid phase) and the density of the continuous phase increase by 100 times to 100,000 times. In this case, since the continuous phase (liquid phase) situated adjacently to the nozzle (at front of the nozzle) has a high viscous resistance and a high density, then the resistance component acting on the ejection of the droplet is massively increased.

If a pressure exceeding this resistance component can be generated, then problems will not arise, but from the viewpoint of practical integration of the nozzles, there are limitations on the structure and the size of the head, and there are also limitations on the possible improvements which can be achieved in actuator performance in terms of structural and material restrictions. Therefore, considering the maximum generated pressure, a case (in other words, a case of low viscous resistance) where the droplet is ejected via a gas phase achieves a greater ejection speed of the droplet ejected from the nozzle compared to a case (in other words, a case of high viscous resistance) where the droplet is ejected directly into the liquid phase without passing through a gas phase. Consequently, ejecting droplets via a gas phase is more beneficial in terms of raising the ejection speed.

Furthermore, in general, in order to create fine droplets, it is preferable to reduce the nozzle diameter, but the loss of pressure (pressure drop) in the flow channels inside the nozzles caused by reduction in the nozzle size increases dramatically in inverse proportion to the fourth power (biquadrate) of the nozzle diameter. Assuming the pressure applied to the nozzle to be a uniform maximum pressure, if the continuous phase of a gas phase is replaced with a liquid phase, and if the nozzle size is also reduced, then a sudden increase in the resistance component in the flow channels constituting the nozzles will occur, and in addition to this, there is also an increase in the resistance component caused by the increase of the 100 times to 100,000 times in the physical values of the viscosity coefficient of the continuous phase and the density of the continuous phase. Therefore, it is absolutely necessary to increase the diameter of the nozzles in order to enable the liquid droplets to be ejected against the resistance. Consequently, in terms of forming the liquid droplets with a small size as well, it is preferable to eject droplets via a gas phase.

In other words, in terms of the viscosity and density in the continuous phase, ejecting the droplets via a gas phase is more beneficial for achieving a high ejection frequency and achieving very fine droplet size, compared to ejecting the droplets directly into the liquid phase, without passing through a gas phase.

Furthermore, in the present embodiment, a recording head is described in which nozzles are arranged in a matrix configuration, but the nozzle arrangement is not limited to a matrix configuration and it is also possible to use a mode where nozzles are aligned in one row following the breadthways direction of the pool 15 shown in FIG. 3A, and a mode where two nozzle rows are arranged in a staggered configuration.

### Description of Supply System

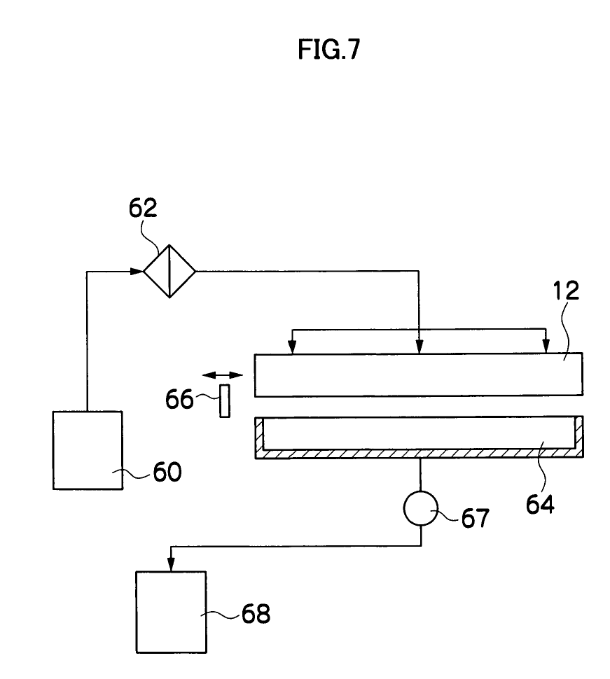

Next, the general composition of the supply system of the dispersion liquid manufacturing apparatus 10 will be described. FIG. 7 is a conceptual diagram showing the composition of an oil supply system in the dispersion liquid manufacturing apparatus 10.

The tank 60 is a base tank for supplying oil to the ejection head 12, and it is the same as the second liquid tank 14 described in FIG. 1. The tank 60 may adopt a system for replenishing oil through a replenishing port (not illustrated), or a cartridge system in which cartridges are exchanged independently for each tank, whenever the residual amount of oil has become low. In a case where the type of liquid constituting the dispersion droplets is changed, then a cartridge based system is suitable. In this case, desirably, type information relating to the liquid (liquid to be dispersed in another liquid) is identified by means of a bar code, or the like, and the ejection of the liquid is controlled in accordance with the liquid type.

If the type of liquid supplied to the ejection head 12 is changed, then cleaning of the ejection head 12 and cleaning of the flow channel between the tank 60 and the ejection head 12 are carried out, and a filter 62 provided between the tank 60 and the ejection head 12 is also replaced with a new one.

Furthermore, as described above, the filter 62 is provided between the tank 60 and the ejection head 12 in order to remove foreign matter and air bubbles. The filter mesh size is desirably equal to or less than the nozzle diameter (generally, approximately 20 μm), and filters of different mesh size should be used appropriately, in accordance with the type of liquid supplied to the ejection head 12.

Desirably, a composition is adopted in which a sub tank (not illustrated) is provided in the vicinity of the ejection head 12, or in an integrated fashion with the ejection head 12. The sub tank has a damper function for preventing variation in the internal pressure of the pressure chamber 52 and the common flow channel 55 and a function for improving refilling characteristics.

Possible modes for controlling the internal pressure of the common flow channel 55 by means of the sub tank include: a mode where the internal pressure of the pressure chamber 52 is controlled by the pressure differential in the liquid head (also referred to as “hydraulic head” or “water head”) between a sub tank which is open to the external air and the pressure chambers 52 inside the ejection head 12; and a mode where the internal pressure of the sub tank and the pressure chambers 52 is controlled by a pump connected to a sealed sub tank; and the like. Either of these modes may be adopted.

### Description of Maintenance of Head

As shown in FIG. 7, a cap 64 forming a device for preventing the drying of the nozzles 51 or increase in the viscosity of the liquid in the vicinity of the nozzles 51 is provided in the dispersion liquid manufacturing apparatus 10, and a blade 66 is provided as a device for cleaning (wiping) the nozzle forming surface (ejection face) on which the nozzles 51 are formed.

The maintenance unit including the cap 64 and blade 66 can be moved relatively with respect to the ejection head 12 by a movement mechanism (not shown), and is moved from a predetermined holding position to a position directly below the ejection head 12, as and when required.

The cap 64 shown in FIG. 7 has a size which enables it to cover the whole of the nozzle forming surface (ejection face) of the ejection head 12. The cap 64 is displaced upwards and downwards in a relative fashion with respect to the ejection head 12 by means of an elevator mechanism (not shown). When the power of the manufacturing apparatus 10 is switched off or when in a print standby state, the cap 64 is raised to a predetermined raised position thereby placing the cap 64 in close contact with the ejection head 12 (the nozzle forming surface of the ejection head 12), in such a manner that the nozzle forming surface is covered with the cap 64 and the nozzle forming surface is protected by the cap 64.

If the liquid supplied to the ejection head 12 is changed, for instance, then in order to expel the liquid remaining in the ejection head 12, the cap 64 is placed in contact with the nozzle forming surface, and suctioning is then carried out using a pump 67 which is connected to the cap 64. If foreign matter becomes mixed into the nozzles, then preliminary ejection (purging, dummy ejection, spit ejection, or the like) is carried out toward the cap 64, in order to remove the foreign matter. The suction operation described above is also carried out in order to expel liquid when liquid is filled into the ejection head for the first time, or when the apparatus starts to be used after being out of use for a long period of time.

The blade 66 functions as a wiping device for removing dirt from the nozzle forming surface by moving while being pressed against the nozzle forming surface, and a hard rubber material, or the like, is suitable for use in the blade 66. In other words, the blade 66 has a prescribed strength (rigidity) and a prescribed elasticity, and the surface thereof has prescribed hydrophobic properties whereby the surface of the blade 66 repulses the various types of liquid that are ejected from the ejection head. The blade 66 is constituted of a member which is capable of wiping and removing liquid (liquid that has solidified on the nozzle forming surface), and other foreign matter, which has adhered to the nozzle forming surface.

Furthermore, although not shown in FIG. 7, the head maintenance mechanism (head maintenance device) of the dispersion liquid manufacturing apparatus 10 includes a blade elevator mechanism (not shown), which moves the blade 66 in the upward and downward directions and thus switches the blade 66 between a state of contact and non-contact with the nozzle forming surface (ejection face), and a cleaning device which removes foreign matter adhering to the blade 66.

### Description of Control System

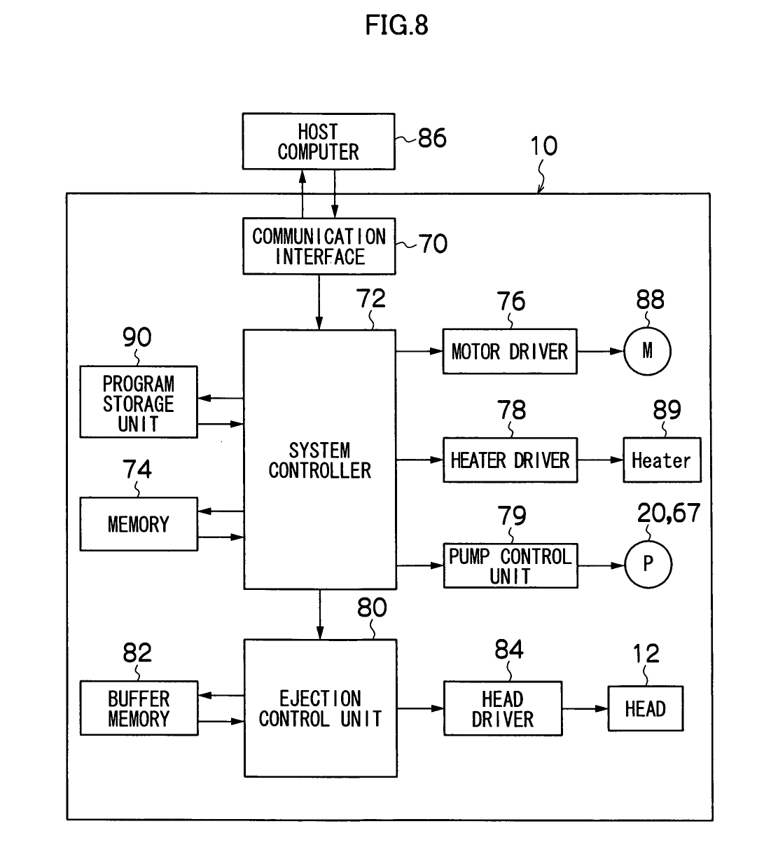

Next, the control system of the dispersion liquid manufacturing apparatus 10 according to the present embodiment will be described. FIG. 8 is a principal block diagram showing the system composition of the dispersion liquid manufacturing apparatus 10. The dispersion liquid manufacturing apparatus 10 includes a communication interface 70, a system controller 72, a memory 74, a motor driver 76, a heater driver 78, a pump controller 79, an ejection controller 80, a buffer memory 82, a head driver 84, and the like.

The communication interface 70 is an interface unit for receiving ejection data sent from a host computer 86. A serial interface such as USB (Universal Serial Bus), IEEE1394, Ethernet (registered trademark), wireless network, or a parallel interface such as a Centronics interface may be used as the communication interface 70. A buffer memory may be mounted in this portion in order to increase the communication speed. The ejection data sent from the host computer 86 is received by the dispersion liquid manufacturing apparatus 10 through the communication interface 70, and is temporarily stored in the memory 74. The memory 74 is a storage device for temporarily storing ejection data inputted through the communication interface 70, and data is written and read to and from the memory 74 through the system controller 72. The memory 74 is not limited to a memory composed of semiconductor elements, and a hard disk drive or another magnetic medium may be used.

The system controller 72 is a control unit for controlling the various sections, such as the communication interface 70, the memory 74, the motor driver 76, the heater driver 78, and the like. The system controller 72 is constituted of a central processing unit (CPU) and peripheral circuits thereof, and the like, and in addition to controlling communications with the host computer 86 and controlling reading and writing from and to the memory 74, or the like, it also generates a control signal for controlling the motor 88 of the conveyance system and the heater 89.

The motor driver 76 is a driver (drive circuit) that drives the motor 88 in accordance with commands from the system controller 72. FIG. 8 shows only one motor 88, but the motor 88 includes a plurality of motors, such as the motor of the movement mechanism of the cap 64 shown in FIG. 7, the motor of the movement mechanism of the ejection head 12 in a mode where the ejection head 12 is moved with respect to the flow channel unit 16, and the like.

The heater driver 78 is a driver which drives the heater 89 in accordance with instructions from the system controller 72. The heater 89 shown in FIG. 8 includes various heaters, such as a temperature adjustment heater for the ejection head 12, a temperature adjustment heater for the pool 15 shown in FIG. 1, a temperature adjustment heater for the second liquid tank 14 and the first liquid tank 18, and the like.

The pump control unit 79 is a control block which controls the pump 20 in FIG. 1 and the pump 67 in FIG. 7, in accordance with command signals from the system controller 72. The pump control unit 79 also functions as a laminar flow control device which controls the laminar flow generated inside the pool 15 shown in FIG. 1.

The ejection controller 80 has a signal processing function for performing various tasks, compensations, and other types of processing for generating ejection control signals from the ejection data stored in the memory 74 in accordance with commands from the system controller 72 so as to supply the generated ejection control signals (ejection command signals) to the head driver 84. Prescribed signal processing is carried out in the ejection controller 80, and the ejection amount and the ejection timing of the droplets from the respective ejection heads 12 are controlled via the head driver 84, on the basis of the ejection data.

The ejection controller 80 is provided with the buffer memory 82; and ejection data, parameters, and other data are temporarily stored in the buffer memory 82 when ejection data is processed in the ejection controller 80. The aspect shown in FIG. 8 is one in which the buffer memory 82 accompanies the ejection controller 80; however, the memory 74 may also serve as the buffer memory 82. Also possible is an aspect in which the ejection controller 80 and the system controller 72 are integrated to form a single processor.

The head driver 84 drives the piezoelectric elements 58 of the ejection head 12 (see FIG. 6) on the basis of the ejection control signal supplied by the ejection control unit 80. A feedback control system for maintaining constant drive conditions for the heads may be included in the head driver 84.

The program storage unit 90 stores control programs for the dispersion liquid manufacturing apparatus 10, and the system controller 72 reads out the various control programs stored in the program storage unit 90, as and when appropriate, and executes the control programs.

In other words, the control system shown in FIG. 8 controls the ejection timing and the ejection volume of the droplets of oil ejected from the ejection head 12, on the basis of the ejection data, as well as controlling the laminar flow in the pool 15 shown in FIG. 3A.

Various information obtained from determination devices (not shown in FIG. 8) such as sensors (a temperature sensor which measures the temperature in the ejection head 12, and the second liquid tank 14 and the first liquid tank 18, and the like, or a flow speed sensor which measures the flow speed of the water in the pool 15), is supplied to the system controller 72, and the various sections of the dispersion liquid manufacturing apparatus 10 are controlled in accordance with the information thus acquired.

In the dispersion liquid manufacturing apparatus 10 having the composition described above, since very fine droplets of oil are ejected from the ejection head 12 via a gas phase, then it is possible to generate desirable oil droplets having a uniform small size, as well as being able to raise the ejection frequency in comparison with a case where the oil droplets are ejected directly into a liquid phase without passing through a gas phase. Furthermore, since the nozzles do not make contact with (or lie in close proximity to) the liquid phase, then there is no reverse flow of water or oil droplets back into the ejection head 12.

Furthermore, by generating a laminar flow in the water into which the oil droplets are ejected, a desirable emulsion is generated which maintains a monodisperse state, without giving rise to combination (coalescence) of the oil droplets in the water.

### Application Embodiment 1

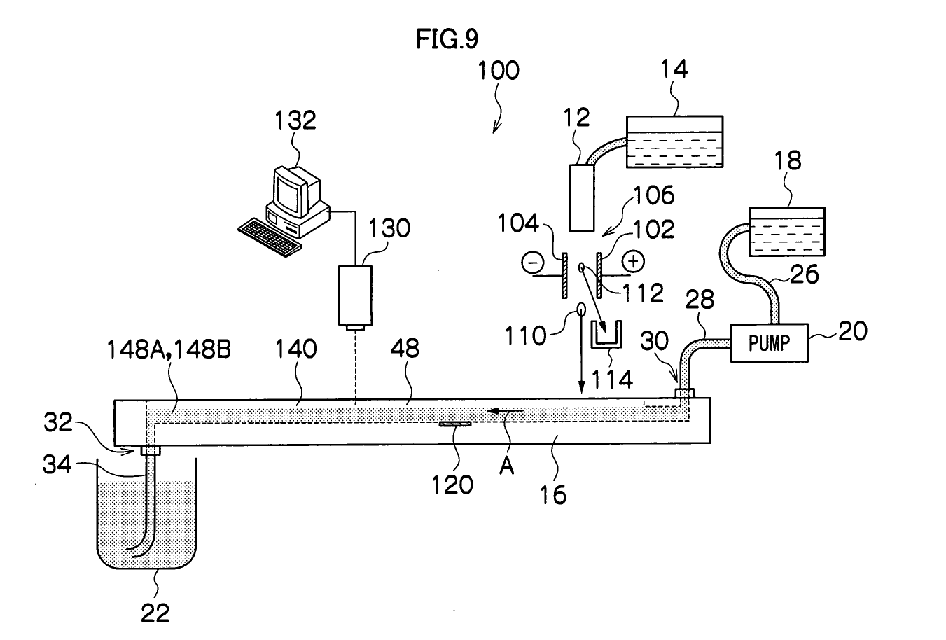

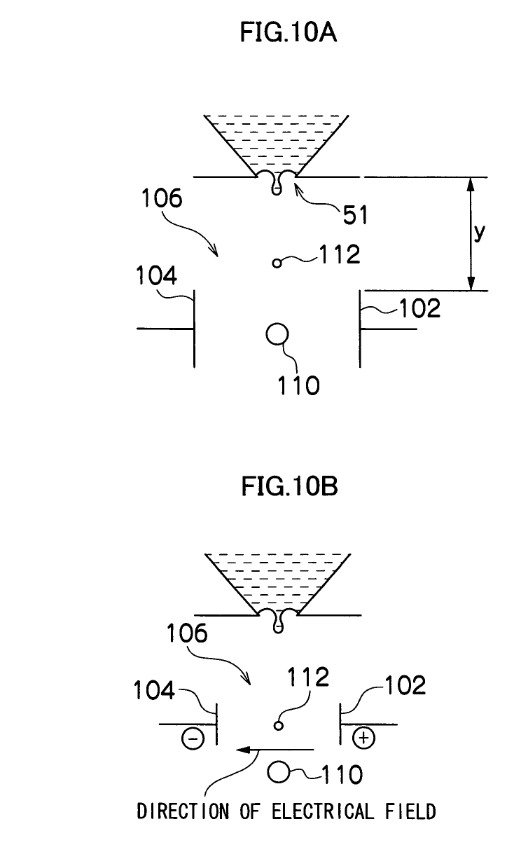

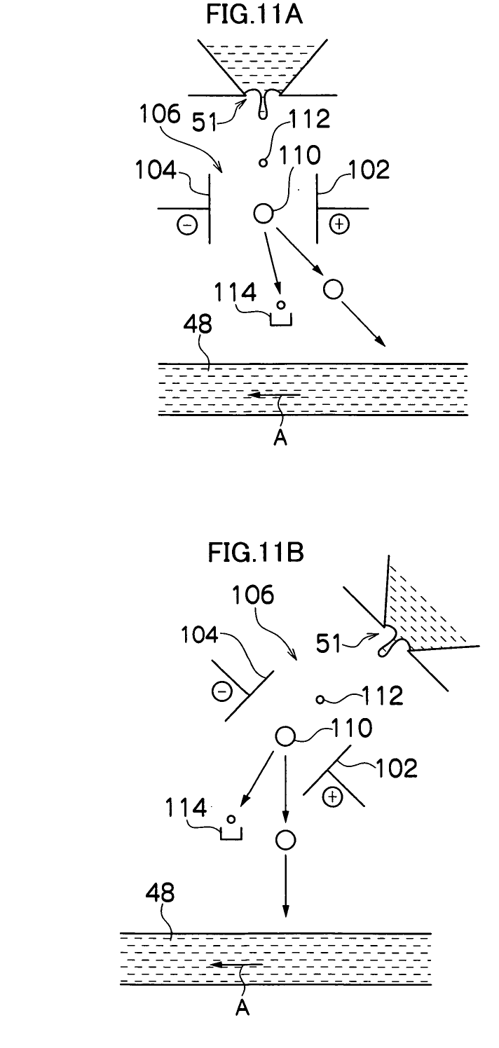

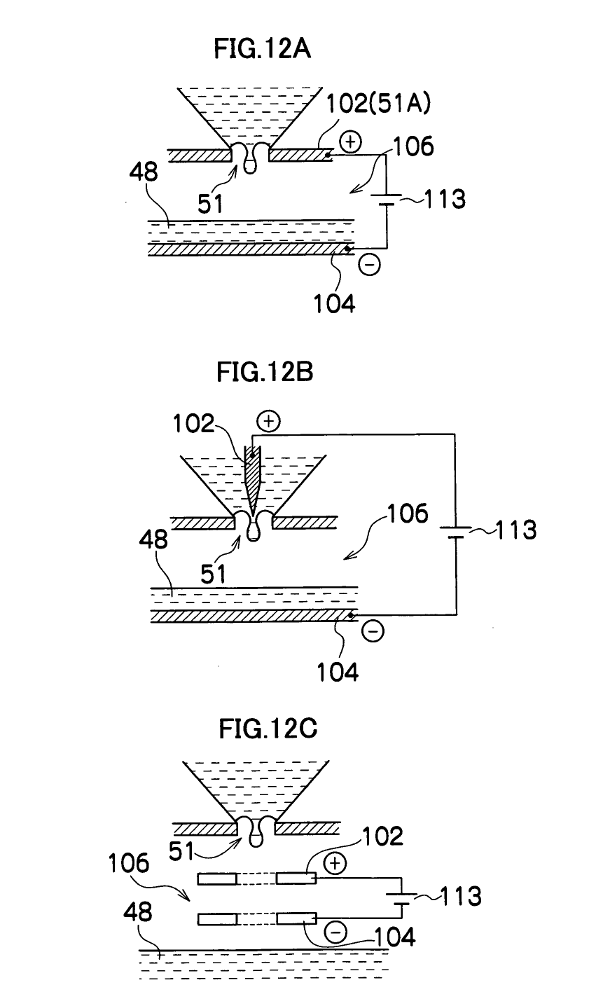

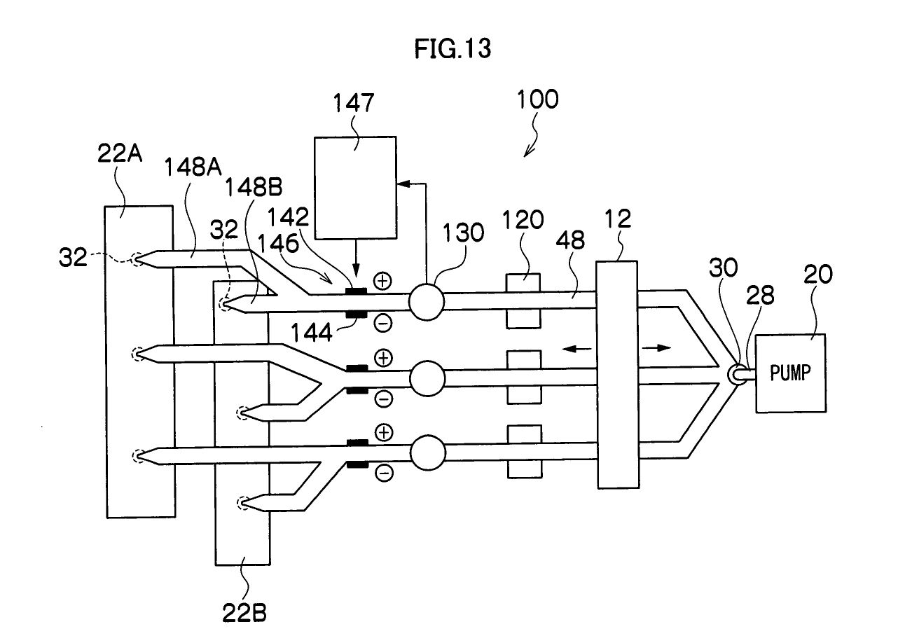

Next, an application embodiment in which the above-described embodiment is modified, will be described with reference to FIGS. 9 to 13. FIG. 9 is a conceptual diagram showing the approximate composition of a dispersion liquid manufacturing apparatus 100 according to the present application embodiment, and FIGS. 10A to 11B are conceptual diagrams showing control of deflection of the direction of flight of the droplets. Furthermore, FIGS. 12A to 12C are diagrams showing further compositional examples of the electrode pair 106 shown in FIG. 9, and FIG. 13 is a diagram of the dispersion liquid manufacturing apparatus 100 shown in FIG. 9, as viewed from the side of the ejection head 12 (from the upper surface side). In FIGS. 9 to 13, items which are the same as or similar to those in FIGS. 1 and 3 are labeled with the same reference numerals and description thereof is omitted here.

In the dispersion liquid manufacturing apparatus 100 shown in FIG. 9, an electrode pair (corresponding to an “electrical field generating device”) 106 is provided which is constituted of a positive electrode 102 and a negative electrode 104. The electrodes 102 and 104 generate an electric field in the space between the ejection head 12 and the micro-channels 48, through which the ejected droplets of oil in flight pass. The electrode pair 106 is connected to a power source (not illustrated), and when a voltage is applied between the positive electrode 102 and the negative electrode 104 opposing the positive electrode 102, by means of this power source, then an electrical field is generated between the positive electrode 102 and the negative electrode 104 (more specifically, the direction of the vector of the generated electrical field is a direction from the positive electrode 102 to the negative electrode 104), in a direction substantially perpendicular to the direction of ejection of the oil droplets.

The droplets of oil ejected in one ejection operation from the ejection head 12 may include satellites (satellite droplets) (liquid droplets having a very small size compared to the main droplets) 112 and the main droplets (droplets having substantially the same size as the theoretical droplet size) 110. In other words, the main droplets 110 may be accompanied by satellite droplets 112, as shown in FIG. 10A. When a charged oil droplet is ejected from the ejection head 12 and the ejected droplets pass between the positive electrode 102 and the negative electrode 104, the main droplet 110 and the satellite droplet 112 are separated from each other due to the electrical field between the positive electrode 102 and the negative electrode 104, and the satellite droplet 112 is recovered (collected) by means of a gutter 114.

In the embodiment shown in FIG. 9, at the timing that the main droplet 110 passes between the positive electrode 102 and the negative electrode 104, an electrical field is not generated between the positive electrode 102 and the negative electrode 104, and the main droplet 110 is deposited onto the water in the micro-channel 48, without the direction of flight of the main droplet 110 being deflected. On the other hand, at the timing that the satellite droplet 112 passes between the positive electrode 102 and the negative electrode 104, an electrical field is generated between the positive electrode 102 and the negative electrode 104, and the direction of flight of the satellite droplet 112 is deflected in such a manner that the satellite droplet 112 is recovered by the gutter 114.

As shown in FIG. 10A, the timing at which the main droplet 110 separates from the liquid inside the nozzle 51 and the timing at which the satellite separates from the liquid in the nozzle 51 are different, and there arises also a difference of flight speed between the main droplet 110 and the satellite droplet 112. Therefore, a time difference arises between the timing at which the main droplet 110 arrives between the positive electrode 102 and the negative electrode 104 and the timing at which the satellite droplet 112 arrives between the positive electrode 102 and the negative electrode 104. Consequently, as shown in FIG. 10B, by generating an electrical field in synchronism with the timing at which the satellite droplet 112 arrives between the positive electrode 102 and the negative electrode 104, the direction of flight of the satellite droplet 112 is deflected and the satellite droplet 112 is recovered by the gutter 114, which is disposed in a position separated by a prescribed distance from the flight path that passes in the vertical downward direction from the nozzle 51.

The timing to generate the electrical field is a time point of t₁ after a drive time point of the piezoelectric element of to at which the piezoelectric element 58 shown in FIG. 6 is driven. The difference between the time points t₀ and t₁ is expressed by a time period of Δt (=y/vₛ) obtained by dividing the distance y from the nozzle 51 to the electrode pair 116 by the fight speed vₛ of the satellite droplet 112. In other words, the time points t₀ and t₁ have a relationship of t₁=to +Δt=t₀+y/vₛ.

Although not shown in the drawings, it is also possible to generate an electrical field in synchronism with the timing of the passage of the main droplet 110, thereby deflecting the direction of flight of the main droplet 110, and to halt generation of an electrical field at the timing of the passage of the satellite droplet 112. If the direction of flight of the satellite droplet 112 is not deflected and the satellite droplet is ejected in a vertical downward direction, then the gutter 114 is provided on the flight path that passes in the vertical downward direction from the nozzle 51.

For example, as shown in FIGS. 11A and 11B, it is also possible to separate the main droplet 110 and the satellite droplet 112 by utilizing the difference in the amount of charge held (carried) by the droplets in flight. If an electrical field is generated at the same magnitude and at the same time intervals when the main droplet 110 and the satellite droplet 112 pass between the electrode pair 106 (for example, if an electrical field is generated continuously), then the main droplet 110 and the satellite droplet 112 receive a force from the electrical field in the same direction, but a difference in flight direction occurs between them due to the difference between the amount of charge held by the main droplet 110 and the amount of charge held by the satellite droplet 112. In this way, by utilizing the difference in the direction of flight of the main droplet 110 and the satellite droplet 112, it is possible to recover the satellite droplet 112 by means of the gutter 114, whereas the main droplet 110 travels until reaching the water inside the micro-channel 48. As shown in FIG. 11B, it is also possible to adjust the angle of ejection (ejection direction) from the nozzle 51 (the ejection head 12) and the positions of the electrode pair 106, in such a manner that the direction of injection of the main droplet 110 is perpendicular with respect to the flow of water inside the micro-channel 48.

By creating an electrical field in the gas phase space through which the oil droplets in flight pass in this way, and thus separating the main droplet 110 and the satellite droplet 112, then the satellite droplets 112 are prevented from reaching the water in the micro-channel 48 and therefore a desirable emulsion containing only liquid droplets of uniform size is created.

If the satellite droplets 112 are dispersed in the water in the micro-channel 48, then it is possible to further reduce the size of the dispersed droplets in comparison with a mode where the main droplets 110 are dispersed in the water in the micro-channel 48. Furthermore, it is also possible to create an electrical field in the direction of ejection of the oil droplets (the direction from the ejection head 12 to the micro-channel 48), and to assist the flight of the oil droplets by means of this electrical field (namely, by using the electrical field as an assist device).

FIGS. 12A to 12C show further examples of the composition of an electrode pair 106 used as an assist device which assists the flight of oil droplets by creating an electrical field in the direction of ejection of the oil droplets. In the aspect shown in FIG. 12A, the nozzle plate 51A in which nozzles 51 are formed is taken to be the positive electrode 102, and the negative electrode 104 is provided at the bottom of the micro-channel 48 so as to oppose the nozzle plate 51A. An electrical field is generated in a substantially parallel direction with respect to the direction of ejection of the oil droplets (flight direction) by applying a prescribed voltage to the electrode pair 106 from the power source 113.

FIG. 12B shows an aspect in which an electrostatic ejection method is used. A needle-shaped electrode provided inside the nozzle 51 is taken to be the positive electrode 102, and the negative electrode 104 is provided at the bottom of the micro-channel 48 so as to oppose the nozzle plate 51A. An electrical field is generated in a substantially parallel direction with respect to the direction of ejection of the oil droplets (flight direction) by applying a prescribed voltage to the electrode pair 106 from the power source 113.

FIG. 12C shows an aspect in which an electrode pair is formed by providing ring-shaped electrodes in mutually opposing fashion following the direction of ejection of the oil droplets, the ring-shaped electrodes being formed with opening sections in the ejection direction of the oil droplets, in the gas phase space between the nozzle 51 and the micro-channel 48. The electrode on the side of the nozzle 51 is taken to be the positive electrode 102, and the electrode on the side of the micro-channel 48 is taken to be the negative electrode 104, an electrical field being generated in a direction substantially parallel to the direction of ejection of the oil droplets (direction of flight) by applying a prescribed voltage to the electrode pair 106 from the power source 113.

The present embodiment (application embodiment) is described above with respect to a mode in which an electrical field is applied in the gas phase space into which the oil droplets are ejected from the ejection head 12, but the scope of application of the present invention is not limited to using an electrical field, and it is also possible to use a field other than an electrical field, such as heat (a drying atmosphere), light, electromagnetic waves, a magnetic field, an atmospheric-pressure plasma, or the like.

For example, by applying heat to the gas phase space into which the oil droplets are ejected (or by creating a drying atmosphere in the gas phase space into which the oil droplets are ejected), it would be possible to further reduce the size of the droplets by promoting drying of the oil droplets ejected from the ejection head 12, or to achieve a phase transition (for example, solation or gelation).

Furthermore, as shown in FIG. 9, a heater 120 which heats the emulsion containing the oil droplets having been dispersed therein is provided in each of the micro-channels 48, on the downstream side of the ejection region where oil droplets are ejected from the ejection head 12, in terms of the direction of flow of the water inside the micro-channels 48.

When a prescribed time period has elapsed after oil droplets are ejected from the ejection head 12 at the ejection timing of the ejection head 12, the heater 120 is switched on and the emulsion in the micro-channels 48 is heated. The oil droplets in the emulsion are solidified (or crystallized or polymerized), resulting in the creation of powder particles.

The heater 120 is switched on and off, and the amount of heat generated is controlled by means of the system controller 72, via the heater driver 78 shown in FIG. 8. Furthermore, a desirable mode is one in which a temperature sensor (temperature measurement device) which measures the temperature of the heating region of the heater 120 is provided, and the heater 120 is controlled in accordance with the temperature measured by the temperature sensor.

In the present embodiment, a heater is described as an example of a solidification device (crystallization device or polymerization device) for the liquid droplets in the emulsion, but it is also possible to apply energy required for solidification (crystallization or polymerization) to the droplets in the emulsion, from outside the micro-channels 48, by means of electromagnetic waves, light (infrared energy, laser energy, or microwaves), or the like. Furthermore, it is also possible to subject the liquid droplets to a reactive change in the emulsion by cooling the emulsion inside the micro-channels 48.

As shown in FIG. 9, a microscope 130 is provided on the downstream side of the heater 120 in terms of the direction of flow of the water in the micro-channels 48, above the micro-channels 48 (at a position which opposes the surface onto which the oil droplets are deposited by the ejection head 12). The microscope 130 serves as an inspection device (measurement device) for the solidified powder particles in the emulsion.

As shown in FIG. 9, the microscope 130 is connected to an analyzer 132, and the image information obtained by the microscope 130 is analyzed by the analyzer 132, thereby yielding information relating to the size (volume), shape and internal state of the solidified powder particles, and the like. The analyzer 132 may be provided as a portion of the control system in FIG. 8, or it may be provided independently from the control system in FIG. 8. The microscope 130 may use a laser diffraction scattering method, a dynamic light scattering method, or the like, and any of these observation methods may be adopted for carrying out the present embodiment.

The present embodiment is described with respect to a mode in which a dispersion liquid as an article of food is manufactured, but it is also possible to apply the present invention to the manufacture of electrical equipment in the field of electronics industry, as described below. Powder particles used in the field of electronics industry are subjected to very strict restrictions (for instance, it is often required that: the manufacturing variation (variation in particle diameter of the manufactured particles) be in the range of ±5 μm at 3 s; and there be no particles having a size greater than a certain value). Therefore highly precise inspection is required. Consequently, rather than inspecting particles again after a large volume of particles have been collected in one vessel, it is much more efficient to inspect each individual particle, in the micro-channel 48, immediately after it has been produced.

A classifying mechanism (sorting mechanism; also referred to as a “classification device”) is provided on the downstream side of the inspection region of the microscope 130 in terms of the flow of water in the micro-channels 48. The size of the droplets ejected from a typical inkjet type of ejection head is confined to a range of fluctuation of several percent, but there is a possibility that droplets having an irregular size may also be included, and therefore a desirable mode is one in which the particles are classified according to standards for the size of the powder particles (dispersed liquid droplets) in the emulsion.

The classification mechanism and the classification step performed by the classification mechanism are now described with reference to FIG. 13. As shown in FIG. 13, an electrode pair (corresponding to a “classification device”) 146 constituted of a positive electrode 142 and a negative electrode 144 opposing the positive electrode 142 is provided on the downstream side of the microscope 130 in terms of the direction of flow of the water in the micro-channel 48. Classification is performed by causing an electrical field generated between the positive electrode 142 and the negative electrode 144 to act on the powder particles, which carry an electrical charge.

In other words, in the inspection step (observation step) performed by the inspection device including the microscope 130 and the analyzer 132, when a particle which does not conform to the specifications (an abnormal particle which is not consistent with the standards (specifications)) is discovered, information (a control signal) on the non-conforming particle is sent from the inspection device to a voltage controller 147 which controls the electrode pair 146. Upon receiving the control signal, the voltage control device 147 applies a prescribed voltage to the electrode pair 146 and generates an electrical field between the positive electrode 142 and the negative electrode 144, thereby classifying the particles.

In this way, by feeding back the inspection results from the inspection step to the classification step, it is possible to carry out the inspection step and the classification step automatically in a combined fashion.

For the classification of the powder particles, it is also possible to use a laser manipulator, a micro manipulator, or a filter having a large number of fine pores, or the like. Furthermore, the classification step according to the present embodiment may also adopt a mode in which the powder particles are classified into two categories, one of which indicates particles sinking in the water, and the other of which indicates particles floating in the water rather than sinking.

The emulsion containing powder particles which have been classified in this way are respectively sent to an extraction vessel 22A and an extraction vessel 22B (which correspond to a “extraction device”) via output flow channels 148A and 148B. The output flow channels 148A and 148B are provided so that the powder particles are output according to the specifications (classes), respectively. The present embodiment describes a mode in which extraction ports 32 are provided in the bottom face of the flow channel unit 16, and emulsion is output to and collected in the extraction vessel 22A and the extraction vessel 22B provided below the flow channel unit 16. However, the positions of the extraction vessel 22A and the extraction vessel 22B are not restricted in particular, provided that they are respectively connected to the output flow channels 148A and 148B via extraction flow channels. Furthermore, it is also possible to provide a mechanism for separating the powder particles from the liquid (water), in such a manner that the powder particles and the liquid are output separately. When an electrical field is applied in the reverse direction by reversing the polarity of the voltage applied between the positive electrode 142 and the negative electrode 144, it is possible to switch the pathways of the powder particles and to determine whether the particles are output to the extraction vessel 22A or are output to the extraction vessel 22B.

In the present application embodiment, a mode is described in which inspection (measurement), and classification (sorting) are carried out after converting the liquid droplets dispersed in the emulsion into powder particles, but the present invention is not limited to this, and it is also possible to carry out the inspection step and the classification step even in a state where the emulsion (emulsified liquid) is output (extracted) while the liquid droplets still remains in a liquid state rather than being converted into particles.

According to this application embodiment, by providing the solidification (powder particle formation) step, the inspection step, and the classification step after generating an emulsion, it is possible to achieve a continuous process of steps after manufacture of an emulsion.

### Application Embodiment 2

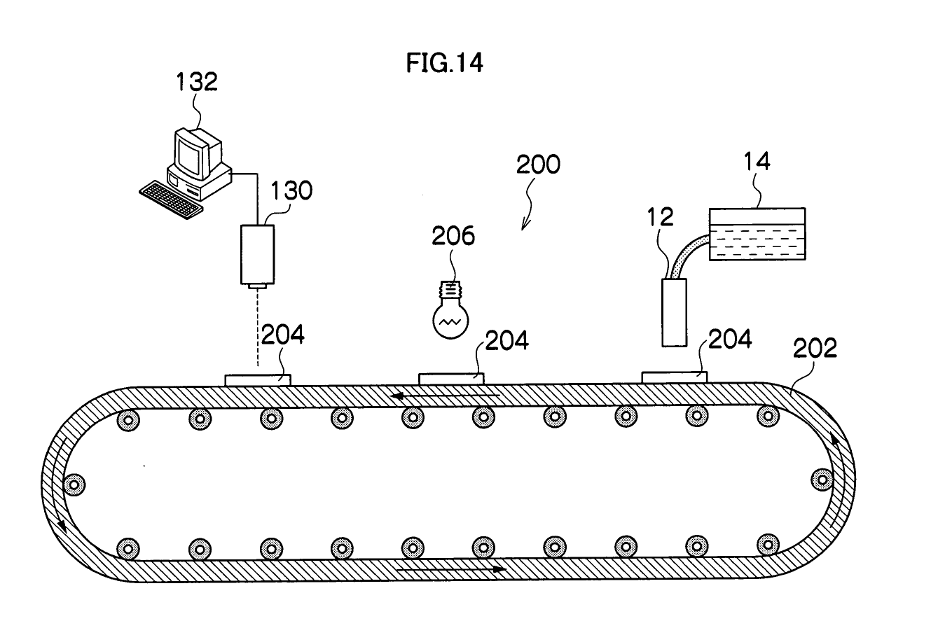

Next, a further application embodiment of the present invention will be described. FIG. 14 is a conceptual diagram showing the approximate composition of a dispersion liquid manufacturing apparatus 200 according to application embodiment 2 of the present invention. In the dispersion liquid manufacturing apparatus 200 to be described in the present application embodiment, containers 204 which accommodate water are conveyed in one direction at a uniform speed by means of a conveyance belt 202, and when each container 204 arrives at the ejection region below the ejection head 12, oil droplets are ejected from the ejection head 12 onto the water in the container 204, thereby creating an emulsion in which oil droplets are dispersed in the water inside the container 204.

The conveyance of the conveyance belt 202 is controlled by the system controller 72 of the control system shown in FIG. 8, via the motor driver 76. In other words, the conveyance speed of the conveyance belt 202 is determined on the basis of the ejection data, and the motor (not shown) which drives the conveyance belt 202 is controlled on the basis of the determined conveyance speed.

A halogen lamp 206 which supplies energy for solidifying the oil droplets in the emulsion is provided on the downstream side of the ejection head 12 in terms of the conveyance direction of the containers 204. An emulsion is created inside the containers 204, and when the container arrives at the irradiation region below the halogen lamp 206, halogen light is radiated from the halogen lamp 206 and the oil droplets in the emulsion are solidified.

In the present embodiment, the halogen lamp 206 is described as an example of the solidification device (e.g., crystallization device and polymerization device) for the liquid droplets in the emulsion, but it is also possible to apply energy required for solidification (e.g., crystallization and polymerization) to the oil droplets in the emulsion, from outside the containers 204, by means of heaters 120 as shown in FIGS. 9 and 13, electromagnetic waves, light (e.g., infrared energy, laser energy, and microwaves), or the like. Furthermore, it is also possible to subject the liquid droplets in the emulsion to a reactive change by cooling the emulsion inside the micro-channels 48.

As shown in FIG. 14, the microscope 130 connected to the analyzer 132 is provided on the downstream side of the halogen lamp 206 in terms of the direction of conveyance of the containers 204, in order to inspect (observe) the powder particles in the emulsion. The inspection step according to the present application embodiment is the same as that of the application embodiment described above (application embodiment 1), and further description thereof is omitted here.

When the inspection step has finished, the containers 204 accommodating the emulsion is output, via a prescribed output path (not illustrated).

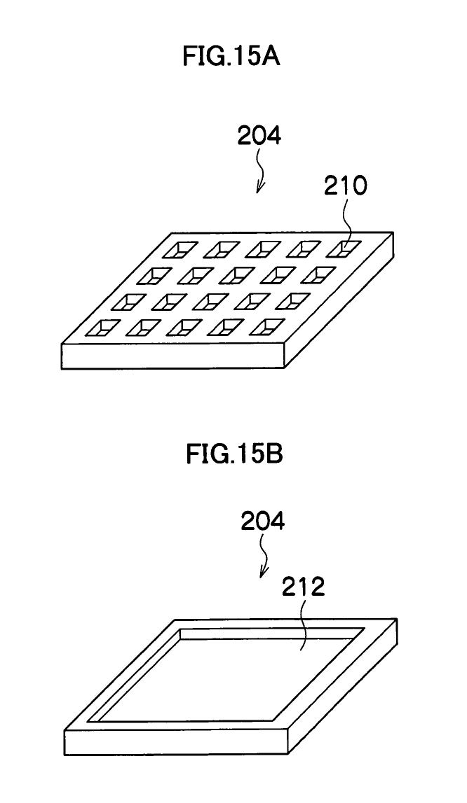

FIGS. 15A and 15B show examples of the container 204 according to the present application embodiment. The container 204 may include small boxes 210 arranged two-dimensionally and each having an opening in the surface onto which oil droplets are deposited, as shown in FIG. 15A. Apart from this composition, the container 204 may include a single unified pool 212, as shown in FIG. 15B.

In a mode where the containers 204 are divided into very small regions, as shown in FIG. 15A, it is possible to perform uniform heat treatment after creation of the emulsion, more rapidly. Moreover, if the container is divided into very small regions, then the inspection step is facilitated. Further, emulsion (emulsified liquid) in a small box (a very small region) for which a failure has been found in the inspection step, can be removed easily.

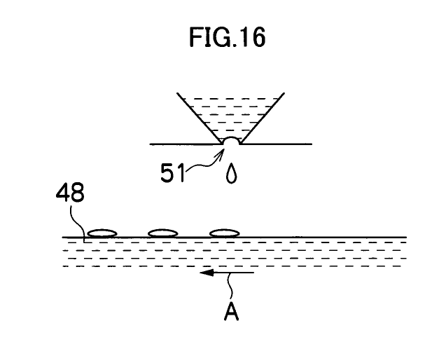

As shown in FIG. 16, depending on the combination of the type of liquid ejected from the head 12 and the type of liquid in the micro-channels 48, cases may arise where the ejected droplets do not enter into (are not incorporated into) the liquid (dispersion medium) in the micro-channels 48, but rather float on the surface of the liquid in the micro-channels 48. Furthermore, whether this case arises or not is also dependent on the ejection force applied when the liquid droplets are ejected from the head 12. If the liquid droplets floating on the liquid surface in the micro-channels 48 in this way are heated and solidified, then nonspherical particles are formed, such as circular disk-shaped particles having a flattened shape, or particles having a shape in which a dome-shaped upper section and an inverted-dome-shaped lower section are joined together.

For example, in the case of circular disk-shaped particles, in contrast to spherical particles, the particles have anisotropic properties with respect to the horizontal direction of the circular disk and the direction perpendicular to same. More specifically, between these directions, there are differences in the properties such as the behavior of the particles in the flow of liquid, and the packing characteristics in an aggregated state, the light scattering characteristics, and so on. In other words, by utilizing the properties that spherical particles do not have and that are intrinsic to nonspherical particles, it is possible to apply the present application embodiment to paints, inks, lubricants, fillers, cosmetics, electronic materials, and the like.

An emulsion in the present embodiment is mainly directed to an article of food, and therefore, it is desirable that the ejection head 12 be free of adhesive, in order to minimize effects on the ejected oil, and that the ejection head 12 be made from a material such as ceramic, silicon, and the like, such that the ejection head 12 is not corroded or changed in quality by the liquid stored in and ejected from the ejection head 12.

Furthermore, the present embodiment describes a mode in which an article of food such as margarine, dressing, or a heath food product, or the like, is manufactured by dispersing very small droplets of organic compound, oil, fat, or the like, in water or a water-based solution, but the present invention can also be used in other applications.

For example, it is possible to manufacture a drug delivery product (a drug suitable for drug delivery system (DDS)) by dispersing a liquid of an organic compound, or an oil or oil-based liquid, containing a pharmaceutical required for the medical care of an illness, in water or a water-based solution. When a drug delivery product is manufactured, since the dispersion liquid manufacturing apparatus (in this case, a device for manufacturing a drug delivery product) is to be installed in a clean room environment, then high cleanliness is required in the whole of the apparatus, and a step for determining foreign matter, and a cleaning step for periodically cleaning the interior of the ejection head 12, are added to the manufacturing process. Furthermore, the size of the liquid droplets ejected from the ejection head is of the sub-micron order, namely, not greater than 1 μm, and similarly to the manufacture of articles of food, the ejection head 12 is manufactured without using adhesive in order to avoid effects on the liquid ejected from the ejection head 12 (for example, in order to prevent the change of the liquid in quality). Moreover, the ejection head 12 is made from a material such as ceramic, silicon, and the like, such that the ejection head 12 is not corroded or changed in quality by the liquid stored in and ejected from the ejection head 12. A desirable mode is one in which a portion of the ejection head is composed of transparent members, in such a manner that the state of soiling (contamination) of the liquid inside the ejection head can be examined visually.

Furthermore, it is also possible to manufacture spherical polymer particles, such as particles used for a liquid crystal spacer or an electronic paper, by dispersing liquid droplets of an organic compound including a monomer in water or a water-based solution, or to manufacture spherical solder particles used for a liquid spacer or an electronic paper, by dispersing solder paste droplets in water. In the manufacture of spherical polymer particles, it is required to provide a heating step (and therefore it is required to provide a heater for performing the heating step) after creating the dispersion liquid, and since there are very strict restrictions on the monodisperse state (to within ±10%) and the particle size, then the nozzles of the ejection head are required to be formed to a very high degree of accuracy.

In a successive processing method, it is difficult to raise productivity, and therefore productivity is preferably raised by adopting a continuous processing method in which the respective steps of creating liquid droplets, heating, classification and inspection are combined into a single continuous process. Moreover, since there is variation in the production volume, a desirable mode is one in which, rather than adopting apparatuses of large size, productivity is adjusted by scaling up the number of apparatuses.

In the manufacture of spherical solder particles, it is necessary to heat the solder in the ejection head to the melting point, and by providing a cooling step after creating the dispersion liquid, the solder droplets are solidified by the cooling process. In the manufacture of spherical solder particles, similarly to the manufacture of spherical polymer particles, there are strict restrictions on the monodisperse state (within ±10%) and the particle size, and the nozzles of the ejection head are therefore required to be formed to a very high degree of accuracy. Moreover, since there is variation in the production volume, a desirable mode is one in which, rather than adopting apparatuses of large size, productivity is adjusted by scaling up the number of apparatuses.

Apart from the application described above, it is also possible to apply the present invention to cosmetics, such as an emulsion in which oil droplets are dispersed in water or a water-based solution, or silica bead particles which form a base material for cosmetics, or tracer particles for measuring the flow rate of a combustion gas, or a dispersion liquid in which droplets of an ionic liquid (a liquid containing essentially only ions), or water or oil are dispersed in another liquid, such as water, oil and an ionic liquid.

In the manufacture of cosmetics, in order to manufacture large volumes at low cost, it is necessary to provide a large number of nozzles in the head, to eject droplets at high frequency, and to scale up the number of apparatuses, and the like. Furthermore, an adhesive-free structure is adopted for the ejection head in order to avoid effects on the liquid ejected from the ejection head, and the ejection head is made from a material such that the ejection head is not corroded or changed in quality by the liquid stored in and ejected from the ejection head.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A dispersion liquid manufacturing apparatus which manufactures a dispersion liquid in which fine droplets of a second liquid are dispersed in a first liquid, the dispersion liquid manufacturing apparatus comprising:
a first liquid accommodating device which accommodates the first liquid; and
an ejection head which has an ejection face opposing the first liquid accommodating device, the ejection head being disposed so that the ejection face is separated from a surface of the first liquid in the first liquid accommodating device by a prescribed distance, the ejection head ejecting the fine droplets of the second liquid from the ejection face to the surface of the first liquid through a gas phase between the ejection face and the surface of the first liquid.

2. The dispersion liquid manufacturing apparatus as defined in claim 1, further comprising a movement device which moves the first liquid and the ejection head relatively to each other at a fixed speed in one direction while the ejection head ejects the fine droplets of the second liquid from the ejection face to the surface of the first liquid.

3. The dispersion liquid manufacturing apparatus as defined in claim 1, further comprising a laminar flow generating device which generates a laminar flow of the first liquid accommodated in the first liquid accommodating device so that the first liquid flows in a flow direction.

4. The dispersion liquid manufacturing apparatus as defined in claim 3, wherein the first liquid accommodating device includes a plurality of grooves which have a width corresponding to a size of the fine droplets, the plurality of grooves being formed along the flow direction of the laminar flow of the first liquid.

5. The dispersion liquid manufacturing apparatus as defined in claim 1, wherein the first liquid accommodating device includes a plurality of recess sections which accommodate the first liquid and which correspond to a size of the fine droplets of the second liquid, the plurality of recess sections being arranged in a two-dimensional configuration in parallel with the ejection face.

6. The dispersion liquid manufacturing apparatus as defined in claim 1, further comprising an electrical field generating device which generates an electrical field in the gas phase between the ejection face and the surface of the first liquid.

7. The dispersion liquid manufacturing apparatus as defined in claim 6, wherein if the ejection head ejects satellite droplets accompanying the fine droplets of the second liquid, then the electrical field generating device separates the satellite droplets from the fine droplets.

8. The dispersion liquid manufacturing apparatus as defined in claim 6, wherein the electrical field generating device assists the fine droplets of the second liquid to be incorporated into the first liquid.

9. The dispersion liquid manufacturing apparatus as defined in claim 1, further comprising a solidification device which solidifies the fine droplets of the second liquid dispersed in the first liquid.

10. The dispersion liquid manufacturing apparatus as defined in claim 1, further comprising an inspection device which inspects at least one of a size, a shape and an internal state of the fine droplets of the second liquid dispersed in the first liquid.

11. The dispersion liquid manufacturing apparatus as defined in claim 1, further comprising a classification device which classifies the fine droplets of the second liquid dispersed in the first liquid.

12. The dispersion liquid manufacturing apparatus as defined in claim 11, further comprising an extraction device which separately extracts the dispersion liquid in which the fine droplets of the second liquid are dispersed in the first liquid, according to classes of the fine droplets of the second liquid classified by the classification device.

13. A method of manufacturing a dispersion liquid, comprising a step of dispersing fine droplets of a second liquid in a first liquid by ejecting the fine droplets of the second liquid to the first liquid through a gas phase.
